(19) United States
(12) Patent Application Publication
(10) Pub. No.: US 2006/0213342 A1
(43) Pub. Date: Sep. 28, 2006

(54) Wear resistant cutting blade

(75) Inventors: Darrel L. Turner, Reedsville, WI (US); Richard E. Wilkey, Watertown, WI (US); Richard L. Wilkey, Hartland, WI (US)

Correspondence Address: MICHAEL BEST & FRIEDRICH, LLP, 100 E WISCONSIN AVENUE, MILWAUKEE, WI, 53202, US

(73) Assignee: Fisher-Barton LLC, Watertown, WI (US)

(21) Appl. No.: 11/086,892

(22) Filed: Mar. 22, 2005

(51) Int. Cl. B26D 1/00

(52) U.S. Cl. 83/13

(57) ABSTRACT

A cutting blade includes a mounting portion and a working portion located at a distance from the mounting portion. The working portion includes a first surface portion at least partially lying in a first plane, a second surface portion at least partially lying in a second plane that is non-parallel to the first plane, and an intermediate surface portion between the first and second surface portions. At least part of the intermediate surface portion has a wear-resistant property that is substantially different from a wear-resistant property of at least part of the second surface portion. The intermediate surface portion can be treated via thermal spray coating, laser hardening, induction hardening, and other similar surface hardening processes. Additionally, a piece of hardened material can be bonded to the intermediate surface portion. Furthermore, the blade thickness adjacent the intermediate surface portion can be increased.

### FIELD OF THE INVENTION

The invention relates to cutting blades used in agricultural applications, and more specifically to cutting blades having radiused portions created by a bend or formation in the blade material.

### BACKGROUND OF THE INVENTION

Numerous types and configurations of cutting blades exist for various agricultural cutting and harvesting applications. A large number of these blades include radiused portions created by a bend or formation in the blade material. Often, a portion of the blade may be bent or formed to improve the cutting and air flow characteristics of the blade, as is the case in some mulching and shredding lawn mower blades. Additionally, the blade may be bent for other reasons, such as for increasing the air flow or fan action in the case of many straw chopping blades used in combines.

The bends in the blade create high pressure areas in and near the radiused portions that are susceptible to wearing by the largely turbulent flowing eddy current of air and debris. This concentrated wearing in the radiused portions often results in an undercutting of the bent portion of the blade (e.g., the shredding fingers of a shredding blade or the paddle portion of a straw chopping blade) by the thinning of the blade material in the radiused portions. If the wear is bad enough, shredding fingers or paddle portions could become weakened to the point that they will bend, thereby causing a change in the blade's geometry that can reduce cutting and airflow performance. During normal usage of the blade, the concentrated wearing in the radiused portions of the blade is often the first visible sign of blade wear, occurring even before significant wearing can be seen on the cutting edge or the trailing edge of the blade.

Prior attempts to account for such wearing typically include bending the blade to a less extreme angle to spread the air flow over a larger surface area of the blade. While this approach can reduce the area of wear concentration on the blade, and thereby increase the life of the blade, a performance loss will typically result. The decreased bend angle will generally reduce shredding capacity and will also generally lower the amount of air flow generated by a paddle portion of a straw chopping blade.

It has also been known to vary the twist angle of any bends in an attempt to minimize the undercutting wear. As with varying the degree of the bend, varying the twist angle also generally results in a noticeable tradeoff between wear resistance and cutting/air flow performance.

Furthermore, it has been known to increase the overall wear resistance of blades using conventional hardening techniques and through the application of wear-resistant coatings over the entire working portions of the blade. While the application of wear-resistant coatings over the entire blade has increased the life of the blade, the concentrated wearing in the radiused portions of the blade remains as the earliest-to-appear, wear-related factor affecting the overall useful life of the blade.

### SUMMARY OF THE INVENTION

The present invention provides an improved cutting blade having a selectively-placed, wear-resistant characteristic, material, or treatment that greatly slows or otherwise accommodates the concentrated wearing in the radiused portions of the blade in relation to the wearing of the cutting edge and the trailing edge of the blade. The improved blade therefore experiences a more preferred and even wear pattern, wherein the radiused portions of the blade wear at substantially the same rate, or even a slower rate, than the cutting edge and the trailing edge. While the blade will still wear in the radiused portions, that wear will not occur substantially earlier in the life of the blade than the wearing of the cutting edge or the trailing edge. Therefore, the blade will generally begin to wear from the tip of the trailing edge inward and the cutting edge will dull before any significant weakening of the material in the radiused portions will occur. Thus, the blade will likely be replaced before the bend geometry is substantially changed to the detriment of cutting and airflow performance.

The wear-resistant characteristic, material, or treatment is selectively placed or applied largely, or perhaps only, in the radiused portions of the blade, instead of over the entire working portions of the blade, as has been previously done. In other embodiments, the wear-resistant characteristic, material, or treatment is applied in greater measure to the radiused portions of the blade than to adjacent portions of the blade. In either case, the radiused portions of the blade are therefore made to be more wear-resistant relative to at least the trailing edge of the blade. A more natural and desirable wear pattern from the outer-most tip of the bent portions of the blade inward is achieved. More importantly, the bent portions of the blade will not be prematurely weakened due to early undercutting wear in the radiused portions of the blade.

Other features and advantages of the invention will become apparent to those skilled in the art upon review of the following detailed description, claims, and drawings.

### BRIEF DESCRIPTION OF THE DRAWINGS

FIG. 1 is a perspective view of a cutting blade embodying the invention.

FIG. 2 is a perspective view of the blade of FIG. 1 showing the application of a wear-resistant coating to a portion of the blade.

FIG. 3 is a section view taken through line 3-3 of FIG. 1.

FIG. 3a is a section view similar to FIG. 3, showing an increased thickness at a bend in the blade.

FIG. 4 is a section view similar to FIG. 3, showing a hard material brazed to a portion of the blade.

FIG. 5 is a section view similar to FIG. 3, showing a laser hardening treatment being performed on a portion of the blade.

FIG. 6 is a section view similar to FIG. 3, showing an induction hardening treatment being performed on a portion of the blade.

FIG. 7 is a perspective view of the blade of FIG. 1 having a larger wear-resistant area.

FIG. 8 is a perspective view of the blade of FIG. 7 showing the application of a wear-resistant coating to a portion of the blade.

FIG. 9 is a section view taken through line 9-9 of FIG. 7.

FIG. 10 is a perspective view a different cutting blade embodying the invention.

FIG. 11 is a section view taken through line 11-11 of FIG. 10.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having” and “comprising” and variations thereof herein is meant to encompass the items listed thereafter and equivalents thereof as well as additional items.

### DETAILED DESCRIPTION

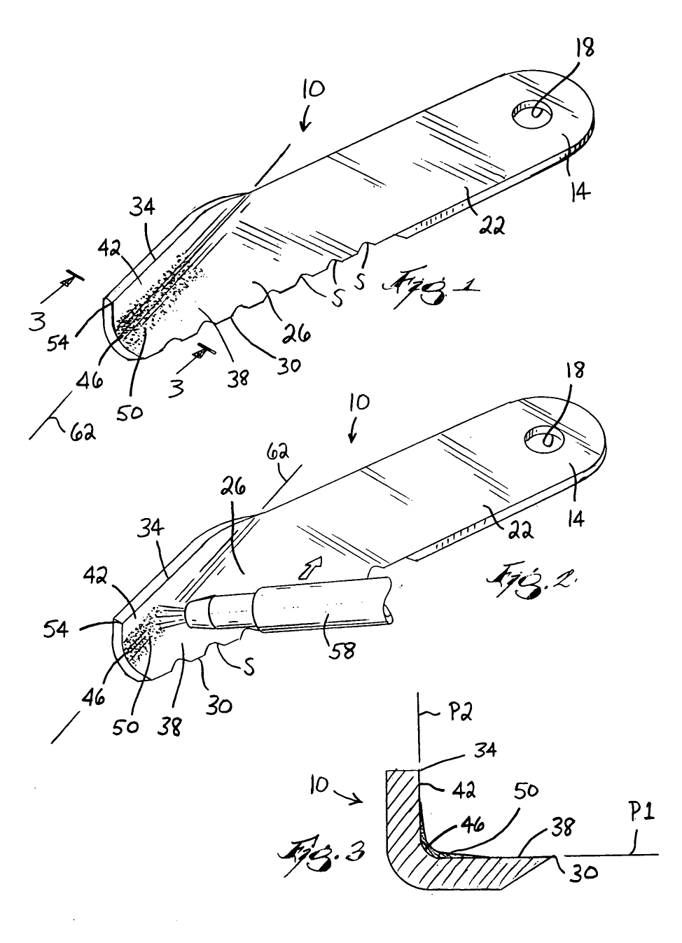

FIGS. 1-3 illustrate a blade 10 embodying the invention. The illustrated blade 10 is of the type commonly referred to as a straw chopping blade. However, as will be discussed in more detail below, the invention is not limited in application to straw chopping blades, but rather can be used with any style or type of cutting blade having one or more bent or otherwise formed portions that create radiused areas of high pressure and turbulence.

The blade 10 includes a mounting portion 14 having therein a mounting hole 18 for securing the blade 10 to a rotating member (not shown). A body portion 22 extends from the mounting portion 14 to a working portion 26. The blade 10 further includes a leading or cutting edge 30 and a trailing edge 34. In the illustrated embodiment, at least a portion of the cutting edge 30 is beveled and includes serrations S for improved cutting performance, however, different cutting edge configurations can also be used. For example, the cutting edge 30 need not be serrated, and can have different bevel configurations or need not be beveled at all.

The blade 10 can be made from any suitable material, such as spring grade steel, and is preferably AISI 10B38 grade steel sold under the trademark MARBAIN and available from Fisher Barton, Inc. of Watertown, Wis. Untreated MARBAIN has a hardness ranging from about 48-55 R_{c}. Of course, other grades of steel can also be successfully used. For example, the blade 10 can be made of any of a group of materials including the following grades of heat treatable, plain carbon or alloy steels: 1074 annealed steel; AISI 5140 through 5160; 51B35 through 51B60; 5135H through 5160H; 6150 and 6150H; 4140 through 4161; 4141H through 4161H; 9255 through 9260; 9255H through 9260H; 1541 through 1566; 15B30 through 15B41; 15B35H through 15B62H; 1037 through 1095; and 10B37 through 10B60, as well as other equivalent chemistries. The blade 10 can be made using conventional fabrication processes such as, for example, stamping, coining, shearing, grinding, shaving, or milling, or by a combination of these processes according to design requirements.

The working portion 26 of the blade 10 includes a first surface portion 38, a second surface portion 42, and an intermediate surface portion 46 between the first and second surface portions 38 and 42. In the illustrated embodiment, the first surface portion 38 extends from the cutting edge 30 to the intermediate surface portion 46, and the second surface portion 42 extends from the intermediate surface portion 46 to the trailing edge 34.

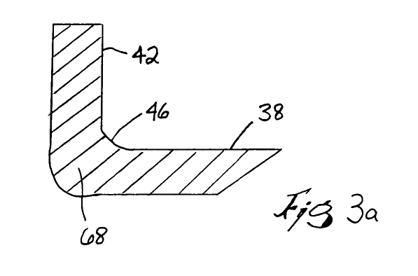

As best seen in FIG. 3, the first surface portion 38 lies at least partially in a first plane P1 and the second surface portion 42 lies at least partially in a second plane P2 that is non-parallel to the first plane P1. As illustrated in FIG. 3, the first and second planes P1 and P2 are substantially normal to one another such that the first and second surface portions 38 and 42 form an angle of about ninety degrees. Of course, the angle between the first and second surface portions 38 and 42 can vary as desired, depending on the desired cutting and airflow characteristics for the blade 10. In other words, the bend angle of the blade 10 can be changed without deviating from the invention.

The intermediate surface portion 46 defines a radiused transition between the first and second surface portions 38, 42. Due to the radiused geometry, the intermediate surface portion 46 is subjected to a turbulent flowing eddy current of air and debris when the blade 10 is in use. To substantially prevent concentrated and premature wearing at the intermediate surface portion 46 of the blade 10, at least part of the intermediate surface portion 46 is treated to have a wear-resistant property that is substantially different from a wear-resistant property of at least part of the second surface portion 42. As illustrated in FIGS. 1-3, the treated intermediate surface portion 46 also has a substantially different wear-resistant property than at least part of the first surface portion 38.

As used herein and in the appended claims, the term “wear-resistant property” means any property that can be attributed to a portion of the blade 10 to substantially reduce or accommodate wear on that portion of the blade 10. In the illustrated embodiments, the wear-resistant properties are material hardness, depth of hardness, and/or material thickness, however, other known wear-resistant properties, such as coefficient-of-friction and the like, can also be included.

As seen in FIGS. 1-3, the wear-resistant property of the intermediate surface portion 46 is increased from that of the first and second surface portions 38, 42 through the application of a thermal spray coating 50 to at least part of the intermediate surface portion 46. Unlike prior art blades that have had the entire working portions coated with wear-resistant coatings, the blade 10 has the thermal spray coating 50 applied substantially only to the intermediate surface portion 46.

The blade 10 therefore experiences a more preferred and even wear pattern, wherein the intermediate surface portion 46 wears at substantially the same rate, or even a slower rate, than the first surface portion 38, including the cutting edge 30, and the second surface portion 42, including the trailing edge 34. While the blade 10 will still wear in the intermediate surface portion 46, that wear will not occur substantially earlier in the life of the blade 10 than the wearing of the cutting edge 30 or the trailing edge 34. Therefore, the blade 10 will generally begin to wear from the distal end or tip 54 of the trailing edge 34 inward, and the cutting edge 30 will dull before any significant weakening of the material in the intermediate surface portion 46 will occur. The accelerated undercutting that can occur in prior art blades is thereby substantially eliminated. Thus, the blade 10 will likely be replaced before the bend geometry is substantially changed to the detriment of cutting and airflow performance.

The thermal spray coating 50 is applied using conventional plasma spraying techniques. An example of a suitable thermal spray apparatus and process is set forth in U.S. Pat. No. 5,217,746 to Lenling, et al, incorporated herein by reference. In one embodiment, the thermal spray material 50 is preferably a hydrogen-based plasma with nickel, chrome, iron, and boron added as the binding elements. Also injected into the plume are tungsten carbide and cobalt particles that give the thermal spray material 50 its hard, wear-resistant characteristics. While the specific chemistry of the thermal spray material 50 can vary as desired, the tungsten carbide and cobalt particles preferably constitute thirty-five to fifty percent (by weight) of the thermal spray material 50. Those skilled in the art of thermal spraying processes may also recognize that other gaseous elements can be substituted for and/or combined with the hydrogen, other elements can be substituted for and/or combined with the binding elements, and other particles can be substituted for and/or combined with the tungsten carbide and cobalt particles. In other words, other thermal spray chemistries that exhibit high hardness and wear-resistant characteristics are acceptable for the thermal spray material 50. Furthermore, while plasma spraying is preferred, other thermal spraying processes, including flame spraying, wire arc spraying, and high velocity oxy-fuel (HVOF) spraying can also be used.

Referring to FIG. 2, the application of the thermal spray coating 50 (indicated by the stippling in FIG. 2) will now be described. First, the intermediate surface portion 46 can be grit-blasted in preparation for accepting the thermal spray material 50. As shown in FIG. 2, the thermal spray material 50 is then preferably applied over at least part of the intermediate surface portion 46 of the working portion 26. Preferably, the spray nozzle 58 is angled and positioned with respect to radius of the intermediate surface portion 46 so that the angle of incidence of the thermal spray material 50 facilitates proper bonding of the coating 50 to the intermediate surface portion 46 and substantially prevents substantial amounts of coating 50 from being applied to the first and second surface portions 38, 42. Proper positioning of the spray nozzle 58 substantially eliminates or reduces the need to mask portions of the first and second surface portions 38, 42.

It is also preferred that the thermal spray material 50 be applied in a direction substantially parallel to the longitudinal axis 62 defined by the intermediate surface portion 46, as shown in FIG. 2. It should be noted, however, that other application techniques, including masking, can also be used to apply the thermal spray coating 50 to the intermediate surface portion 46, as illustrated in FIGS. 1 and 3, without deviating from the invention.

After the thermal spray coating 50 is applied, the blade 10 is placed in a furnace operating at approximately 1950 degrees F. to bond the coating 50 to the blade 10. Bonding occurs by diffusion of the binding elements across the interface between the substrate of the blade 10 and the thermal spray material 50.

As the thermal spray material 50 fuses, it becomes more dense as the porosity is reduced. During fusing, the thermal spray material 50 also becomes stronger and harder. In the illustrated embodiment, the fused thermal spray material 50 has a hardness value greater than 58 R_{c}, with at least some of the particles having hardness values greater than or equal to 70 R_{c}. In the illustrated embodiment, the layer of thermal spray coating 50 has a thickness between about 0.005-0.020 inches, and more preferably about 0.010 inches after fusing. Of course, other thicknesses of the fused thermal spray material 50 can be used. Those skilled in the art will understand that some coating processes, such as HVOF spraying, will not require fusing.

After fusing, the blade 10 is preferably heat treated using conventional techniques including, but not limited to induction hardening; austempering; austempering and tempering; martempering; quenching; and tempering to harden the non-coated portions of the blade 10 to between about 48-58 R_{c}, and more preferably to between about 48-52 R_{c} when MARBAIN is used for the blade material. Therefore, after fusing and heat treating, the thermal spray material 50 on the intermediate surface portion 46 will have a higher hardness value than the surrounding blade material of the first and second surface portions 38, 42, and the intermediate surface portion 46 will be more wear-resistant than the first and second surface portions 38, 42.

Those skilled in the art will also understand that the wear-resistant property in the intermediate surface portion 46 can be increased relative to the wear-resistant properties of the first and/or second surface portions 38, 42 by providing a greater thickness of thermal spray material 50 on the intermediate surface portion 46 than on the first and second surface portions 38, 42. In other words, if it is desired to coat much or substantially all of the working portion 26 of the blade 10 with thermal spray material 50 to provide the hardened material 50 over much or all of the working portion 26, the thermal spray material 50 can be applied more heavily (i.e., to achieve a thicker layer of material 50) to at least the intermediate surface portion 46 to accommodate for the increased wear expected in the radiused intermediate portion 46. In this case, the stippling 50 in FIG. 1 would represent the increased thickness of thermal spray material 50 applied to the intermediate surface portion 46, as compared to that applied to the first and second surface portions 38, 42.

In this manner, the wear rates of the first, second, and intermediate surface portions 38, 42, and 46 will be generally the same, however, the presence of an additional, thicker amount of the material 50 on the intermediate surface portion 46 will accommodate for the expected increased wear on the intermediate surface portion 46. The thicker layer of material 50 will help to achieve the desired preferential wearing of the blade 10 and will substantially delay undercutting to the point where the blade is weakened.

In yet another alternative, the blade itself could be formed with a generally thicker body adjacent the intermediate surface portion 46 to accommodate increased wearing and to provide the preferential wearing desired. FIG. 3a illustrates an example of a thickened body portion 68 adjacent the intermediate surface portion 46. The thickened body portion 68 could be formed by adding material to the portion of the blade adjacent the intermediate surface portion 46 or by removing material from the portions of the blade adjacent the first and second surface portions 38, 42.

FIG. 4 illustrates an alternative embodiment, in which a blade 70 is treated in a different way to achieve the same preferential wear effect described above with respect to the blade 10. Like parts of the blade 70 have been given like reference numerals. In the blade 70, the intermediate surface portion 46 is given a greater wear-resistant property than either of the first and second surface portions 38, 42 by application of a secondary piece of material 74 to at least part of the intermediate surface portion 46. In the illustrated embodiment, the secondary piece of material 74 is a piece of carbide grade material, and preferably a tungsten carbide material that is configured to be received in the intermediate surface portion 46 and brazed thereto using conventional brazing techniques. The blade 70 is then heat treated as described above.

Preferably, the brazing material 78 is a thermal sprayed brazing material. The secondary piece of carbide material 74 typically has a hardness value greater than 58 R_{c}, with at least some of the particles having hardness values greater than or equal to 70 R_{c}.

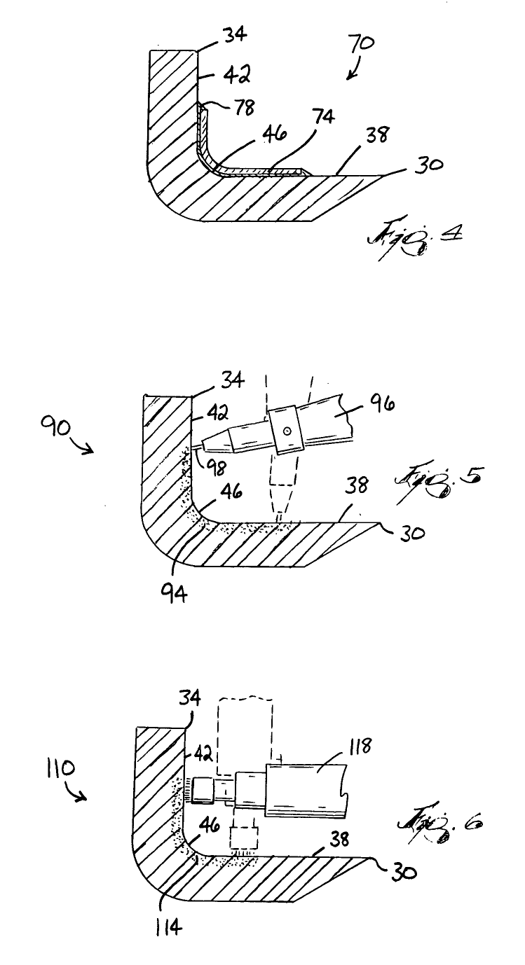

FIG. 5 illustrates another alternative embodiment, in which a blade 90 is treated in a different way to achieve the same preferential wear effect described above with respect to the blade 10. Like parts of the blade 90 have been given like reference numerals. In the blade 90, the intermediate surface portion 46 is given a greater wear-resistant property than either of the first and second surface portions 38, 42 by application of a laser hardening process to at least part of the intermediate surface portion 46. The blade 90 is then heat treated as described above.

Laser hardening the intermediate surface portion 46 creates a hardened zone 94 (indicated generally by the stippling in FIG. 5) on and beneath the intermediate surface portion 46 to a depth of about 0.010-0.040 inches, and more preferably to about 0.020 inches. The hardness of the laser hardened zone 94 is in the range of 58-70 Rc, and about 60 Rc when MARBAIN is used for the blade material.

As shown in FIG. 5, a laser 96, typically, but not limited to a CO₂ or Nd:YAG laser can be used. While other laser apparatus are believed to be suitable, a 6 KW CO₂ laser operating at 85% power can be successfully used. The beam 98 of the laser 96 is focused to a suitable size and shape for the laser and work piece application. The blade 90 is moved relative to the laser beam 98 or the beam 98 may be moved relative to the blade 90. Of course, a hybrid of the two may be most suitable. While the relative speed and pattern of travel between the blade 90 and the laser beam 98 are variables that may be optimized for the laser hardening of the intermediate surface portion 46, in a preferred embodiment of the invention, the beam of laser radiation 98 is generally rectangular in cross section such that the beam 98 is approximately ⅜ inch wide and has a relatively narrow thickness or depth on the order of less than 1/10 inch. The appropriate rate of travel of the beam 98 along the work piece will depend on the thickness of the beam 98, the depth or thickness of the blade 90 adjacent the intermediate surface portion 46 to be hardened, and the material to be used. However rates of travel of 45-100 inches per minute can be successfully used. Accordingly, the relationships of the width or swath of the beam 98, the thickness of the beam 98 and the rate of travel are interdependent factors in optimizing the laser hardening process.

FIG. 6 illustrates another alternative embodiment, in which a blade 110 is treated in a different way to achieve the same preferential wear effect described above with respect to the blade 10. Like parts of the blade 110 have been given like reference numerals. In the blade 110, the intermediate surface portion 46 is given a greater wear-resistant property than either of the first and second surface portions 38, 42 by application of an induction hardening process to at least part of the intermediate surface portion 46. The blade 110 is then heat treated as described above.

Induction hardening the intermediate surface portion 46 creates a hardened zone 114 (indicated generally by the stippling in FIG. 6) on and beneath the intermediate surface portion 46 to a depth of about 0.040 inches. The hardness of the induction hardened zone 114 is in the range of 58-70 Rc, and preferably about 60 Rc when MARBAIN is used as the blade material. Preferably, the induction hardening process is a conventional, high-frequency induction hardening process using a coil 118.

Each of the blades 10, 70, 90, and 110 includes an intermediate surface portion 46 that has a greater wear-resistant property than either of the first and second surface portions 38, 42. Those skilled in the art will understand that other techniques for hardening or otherwise increasing the wear-resistant property of the intermediate surface portion 46 can be substituted for and/or used in addition to those discussed above. For example, other surface-hardening processes, such as diffusion processes like carburizing or boronizing processes, can be used in a similar manner to the induction hardening and laser hardening processes described above.

Additionally, it is to be understood that the above-mentioned surface hardening processes can also used to surface harden much or all of the working portion 26 of the blades, yet can be applied in a manner to create an elevated wear-resistant property for the intermediate portion 46 as compared to the first and/or second portions 38, 42. For instance, laser hardening, induction hardening, carburizing, boronizing, and other similar processes could be applied by first hardening the entire surface of the working portion, and then providing additional treatment to the intermediate surface portion 46 to further increase the depth of the hardened region underlying the intermediate surface portion 46. If desired, the first and second portions 38 and 42 could be masked during the additional treatment of the intermediate surface portion 46 to facilitate creating the differential in wear-resistant properties. A deeper hardened region at the intermediate surface portion 46 would similarly achieve the desired preferential wearing.

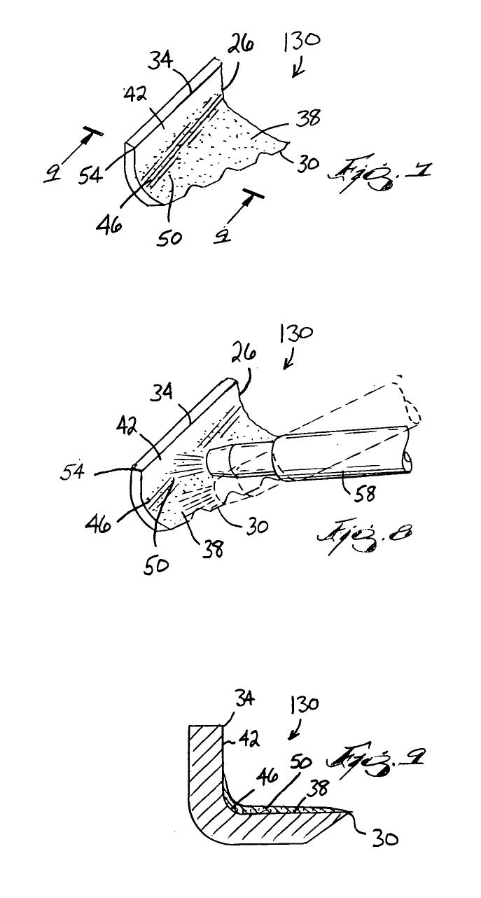

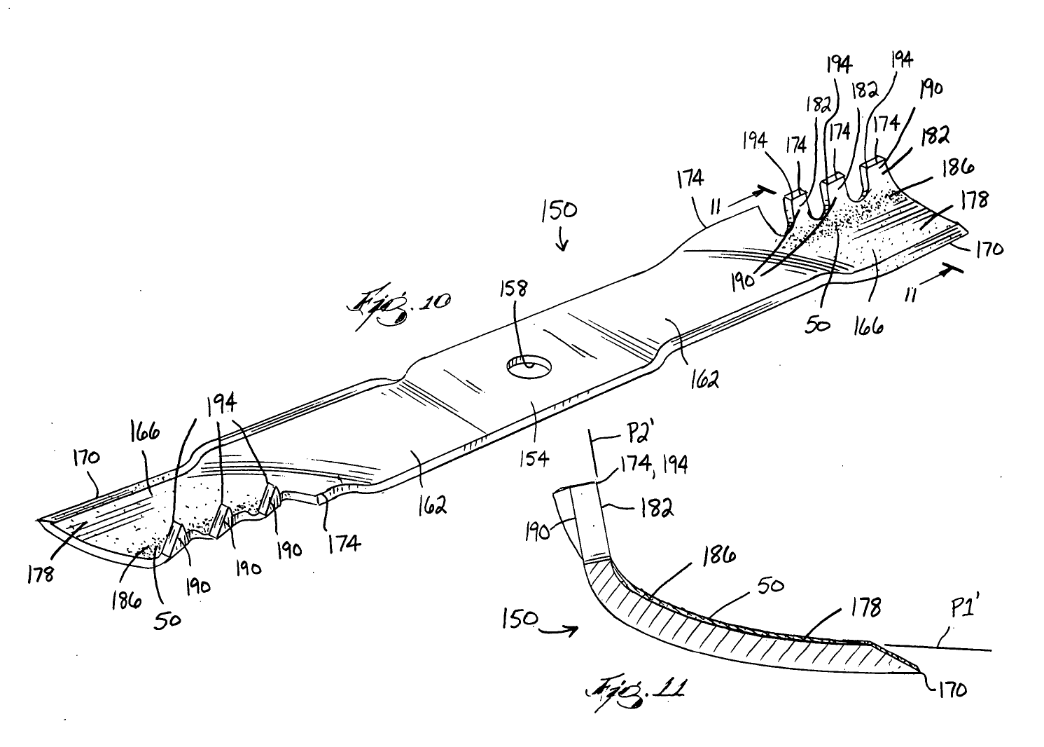

In some applications, it may also be desirable to increase the wear-resistant property of the cutting edge 30 and/or the entire first surface portion 38 using the same techniques described above for increasing the wear-resistant property of the intermediate surface portion 46. This may be desirable for applications in which the cutting edge 30 and/or portions of the first surface portion 38 experience accelerating wearing during use. FIGS. 7-9 illustrate a blade 130 in which at least part of the first surface portion 38 and at least part of the intermediate surface portion 46 are both treated to have a wear-resistant property that is substantially different from the wear resistant property of at least part of the second surface portion 42, which is left substantially untreated.

In the blade 130 shown in FIGS. 7-9, the first surface portion 38 and the intermediate surface portion 46 are both treated with the thermal spray coating 50 in the manner discussed above with respect to the blade 10 of FIGS. 1-3. However, any of the treatment methods discussed above with respect to the blades 70, 90, and 110 of FIGS. 4-6 can also be used, either separately or in combination, to treat at least part of both the first surface portion 38 and the intermediate surface portion 46.

As mentioned above, the invention can be practiced on substantially any blade having one or more bent or formed portions that may otherwise experience the premature wearing or undercutting in the radius that defines the transition to the bent or formed portion. For example, FIGS. 10 and 11 illustrate a rotary mulching/shredding blade 150 sold by Fisher Barton, Inc. of Watertown, Wis. under the trademark ELIMINATOR. The blade 150 is described in detail in U.S. Pat. No. 6,487,840 issued Dec. 3, 2002, which is hereby incorporated by reference.

The blade 150 includes a central mounting portion 154 having a mounting hole 158 for securing the blade 150 to a rotating member (not shown). Body portions 162 extend from either side of the mounting portion 154 to working portions 166 at opposite ends of the blade 150. Each end of the blade 150 further includes a leading or cutting edge 170 and a trailing edge 174. In the illustrated embodiment, at least a portion of each cutting edge 170 is beveled for improved cutting performance, however, different cutting edge configurations can also be used. For example, the cutting edges 170 can be serrated, and can have different bevel configurations or need not be beveled at all.

The working portions 166 of the blade 150 are substantially identical, and only one will be described in detail. Each working portion 166 includes a first surface portion 178, one or more second surface portions 182, and an intermediate surface portion 186 between the first and second surface portions 178 and 182. In the illustrated embodiment, the first surface portion 178 extends from the cutting edge 170 to the intermediate surface portion 186. The second surface portions 182 are formed by one or more spaced shredding teeth or fingers 190 extending from the intermediate surface portion 186 to the trailing edge 174.

As best seen in FIG. 11, the first surface portion 178 lies at least partially in a first plane P1′ and the second surface portions 182 lie at least partially in a second plane P2′ that is non-parallel to the first plane P1′. As illustrated in FIG. 11, the first and second planes P1′ and P2′ form an obtuse angle with respect to one another such that the first and second surface portions 178 and 182 form an angle of greater than ninety degrees. Of course, the angle between the first and second surface portions 178 and 182 can vary as desired, depending on the desired cutting and airflow characteristics for the blade 150. In other words, the bend angle of the blade 150 can be changed without deviating from the invention. Additionally, it is understood that the shredding teeth 190 can be twisted with respect to the cutting edge 170 either outwardly (as shown in FIGS. 10 and 11) or inwardly (not shown).

The intermediate surface portion 186 defines a radiused transition between the first and second surface portions 178, 182. Due to the radiused geometry, the intermediate surface portion 186 is subjected to a turbulent flowing eddy current of air and debris when the blade 150 is in use. To substantially prevent concentrated and premature wearing at the intermediate surface portion 186 of the blade 150, at least part of the intermediate surface portion 186 is treated to have a wear-resistant property that is substantially different from a wear-resistant property of at least part of the second surface portions 182. As illustrated in FIGS. 10 and 11, the first surface portion 178, including the cutting edge 170, is also treated to have a substantially different wear-resistant property than at least part of the second surface portions 182, however, this need not be the case. Instead, the first surface portion 178 can also be left untreated as described with respect to the blade 10 of FIGS. 1-3.

As seen in FIGS. 10 and 11, the wear-resistant property of the intermediate surface portion 186 and the first surface portion 178 is increased from that of the second surface portions 182 through the application of the thermal spray coating 50 in the same manner discussed above with respect to the blades 10 and 130.

The blade 150 therefore experiences a more preferred and even wear pattern, wherein the intermediate surface portion 186 wears at substantially the same rate, or even a slower rate, than the first surface portion 178, including the cutting edge 170, and the second surface portions 182, including the trailing edge 174 as defined by each of the shredding fingers 190. While the blade 150 will still wear in the intermediate surface portion 186, that wear will not occur substantially earlier in the life of the blade 150 than the wearing of the cutting edge 170 or the trailing edge 174. Therefore, the blade 150 will generally begin to wear from the distal ends or tips 194 of the shredding fingers 190, and the cutting edge 170 will dull before any significant weakening of the material in the intermediate surface portion 186 will occur. The accelerated undercutting that can occur in prior art blades is thereby substantially eliminated. Thus, the blade 150 will likely be replaced before the bend geometry is substantially changed to the detriment of cutting and airflow performance.

While the blade 150 is illustrated as being treated with the thermal spray coating 50, it is understood that any of the other treatment methods discussed above with respect to the blades 70, 90, and 110 can also be used, either separately, or in combination, to treat at least part of the first surface portion 178 and/or the intermediate surface portion 186.

Various features of the invention are set forth in the following claims.

1. A cutting blade comprising:
a mounting portion; and
a working portion located at a distance from the mounting portion, the working portion having:
a first surface portion at least partially lying in a first plane;
a second surface portion at least partially lying in a second plane that is non-parallel to the first plane; and
an intermediate surface portion between the first and second surface portions, at least part of the intermediate surface portion having a wear-resistant property that is substantially different from a wear-resistant property of at least part of the second surface portion.

2. The cutting blade of claim 1, wherein the at least part of the intermediate surface portion includes a wear-resistant coating having a thickness greater than a thickness of any wear-resistant coating on the at least part of the second surface portion.

3. The cutting blade of claim 2, wherein the second surface portion includes substantially no wear-resistant coating.

4. The cutting blade of claim 2, wherein the wear-resistant coating is a thermal spray coating.

5. The cutting blade of claim 1, wherein the at least part of the intermediate surface portion includes material that is harder than material of the at least part of the second surface portion.

6. The cutting blade of claim 1, further comprising a piece of material coupled to the at least part of the intermediate surface portion, the piece of material being harder than the material of the at least part of the second surface portion.

7. The cutting blade of claim 1, wherein the at least part of the intermediate surface portion is hardened to a depth greater than a hardened depth of the at least part of the second surface portion.

8. The cutting blade of claim 1, wherein the at least part of the intermediate surface portion has a wear-resistant property that is also substantially different from a wear-resistant property of at least part of the first surface portion.

9. The cutting blade of claim 1, wherein the intermediate surface portion defines a radius.

10. The cutting blade of claim 1, wherein the wear-resistant property is at least one of a material hardness, a hardness depth, and a material thickness.

11. A method of manufacturing a cutting blade having a mounting portion and a working portion at a distance from the mounting portion, the working portion including a first surface portion at least partially lying in a first plane, a second surface portion at least partially lying in a second plane that is non-parallel to the first plane, and an intermediate surface portion between the first and second surface portions, the method comprising:
providing at least part of the intermediate surface portion with a first wear-resistant property; and
providing at least part of the second surface portion with a second wear-resistant property different from the first wear-resistant property.

12. The method of claim 11, wherein providing at least part of the intermediate surface with a first wear-resistant property includes applying a wear-resistant coating to the at least part of the intermediate surface portion.

13. The method of claim 12, wherein applying a wear-resistant coating includes applying the wear-resistant coating with a thickness greater than a thickness of any wear-resistant coating on the at least part of the second surface portion.

14. The method of claim 12, wherein providing at least part of the second surface portion with a second wear-resistant property different from the first wear-resistant property includes not applying substantially any wear-resistant coating to the at least part of the second surface portion.

15. The method of claim 12, wherein applying the wear-resistant coating includes applying a thermal spray coating.

16. The method of claim 11, wherein providing at least part of the intermediate surface with a first wear-resistant property includes hardening at least some material of the intermediate surface portion to a higher hardness than at least some material of the second surface portion.

17. The method of claim 11, wherein providing at least part of the intermediate surface with a first wear-resistant property includes coupling a piece of material to the at least part of the intermediate surface portion, the piece of material being harder than the material of the at least part of the second surface portion.

18. The method of claim 11, wherein providing at least part of the intermediate surface portion with a first wear-resistant property includes hardening the at least part of the intermediate surface portion to a depth greater than a hardened depth of the at least part of the second surface portion.

19. The method of claim 11, further including providing at least part of the first surface portion with a third wear-resistant property different from the first wear-resistant property.

20. The method of claim 11, wherein providing at least part of the intermediate surface portion with a first wear-resistant property includes:
treating the at least part of the intermediate surface portion with one of a coating, a hardening process, and an attached piece of material; and
leaving the at least part of the second surface portion substantially untreated so that the at least part of the intermediate surface portion is substantially more wear-resistant than the at least part of the second surface portion.
